(19) United States
(12) Patent Application Publication
(10) Pub. No.: US 2022/0395994 A1
(43) Pub. Date: Dec. 15, 2022

(54) SHAVING HEAD ASSEMBLY, HANDLE ASSEMBLY AND INDUCTIVE SHAVER

(71) Applicant: SHENZHEN SOOCAS TECHNOLOGY CO., LTD., Shenzhen, Guangdong (CN)

(72) Inventors: Yunfeng QIU, Shenzhen, Guangdong (CN); Zhishan LIU, Shenzhen, Guangdong (CN); Xiaowu WANG, Shenzhen, Guangdong (CN)

(21) Appl. No.: 17/777,223

(22) PCT Filed: Nov. 13, 2020
(86) PCT No.: PCT/CN2020/128545

§ 371 Date: May 16, 2022

(30) Foreign Application Priority Data
Nov. 15, 2019 (CN) 201911118874.6

(51) Int. Cl. B26B 19/38; B26B 19/14

(52) U.S. Cl. CPC B26B 19/3886; B26B 19/14; B26B 19/386; B26B 19/388

(57) ABSTRACT

The present application provides a shaving head assembly, a handle assembly, and an inductive shaver. The inductive shaver includes the shaving head assembly and the handle assembly. The shaver is configured with the first conductive path, the first end of the first conductive path is the holder or the cutters in the shaving head assembly, and the second end is connected to the circuit board assembly in the handle assembly. When shaving, the holder (or the cutters) is arranged approaching the human skin 1 such as the chin and cheeks; because the human skin has a certain electric charge, when the human skin directly contacts or approaches the holder (or the cutters), the holder (or the cutters) will absorb human skin capacitance formed between the approaching position and the ground, which is the first inductive capacitor.

The present application claimed priority of Chinese patent application, with Application No. 201911118874.6, filed on Nov. 15, 2019, submitted to CNIPA, the content of which is incorporated herein by reference.

### TECHNICAL FIELD

The present application relates to the technical field of shaver, and more particularly to a shaving head assembly, a handle assembly, and an inductive shaver.

### BACKGROUND

The existing electric shaver startup method generally includes a key switch and a toggle switch. The long-term use of the key switch and the toggle switch will cause the metal shrapnel of the internal components of the switch to fatigue and lose elasticity, and the switch will fail, thereby failing to maintain the reliability of the power supply.

### Technical Problem

An object of embodiments of the present application is to provide a shaving head assembly, a handle assembly, and an inductive shaver, to solve the technical problem that long-term use of the key switch and the toggle switch of the existing electric shaver will affect the reliability.

### SUMMARY

An embodiment of the present application provides a shaving head assembly, which includes: a head cover; a holder, mounted on the head cover; a cutting unit, mounted on the holder, and the cutting unit comprising cutters mounted on the holder and a rotating cutter head arranged in cutters; and a connecting seat, configured for connecting to a handle assembly, and the connecting seat being electrically connected with the holder;

the holder is served as a first end of a first conductive path, and the first conductive path is configured for receiving a first inductive capacitor between the holder and the ground when the holder approaches or contacts human skin; or

the cutters are served as a first end of a first conductive path, and the first conductive path is configured for receiving a first inductive capacitor between the cutters and the ground when the cutters approach or contact human skin.

Optionally, when the holder is served as the first end of the first conductive path, the holder is configured as a conductor; or an outer surface of the holder is provided with a conductive layer; and

when the cutters are served as the first end of the first conductive path, the cutters are configured as conductors; or an outer surface of the cutters is provided with a conductive layer.

Optionally, the holder is provided with a mounting groove, the cutting unit is arranged in the mounting groove, the holder is mounted with a fixing plate configured for limiting the cutting unit, and the holder is electrically connected to the head cover and serves as a part of the first conductive path.

Optionally, the head cover is provided with a mounting hole, and the holder is swingably arranged in the mounting hole.

Optionally, the shaving head assembly further includes a gear frame aligned with the head cover, a cover plate mounted on one end of the gear frame, and a snap-fit member mounted on the cover plate and engaged with the head cover, the head cover is electrically connected with the snap-fit member and serves as a part of the first conductive path.

Optionally, a middle part of the cover plate is provided a positioning post, the snap-fit member is provided with a positioning hole configured for the positioning post passing through; the snap-fit member is provided with a plurality of positioning buckles circumferentially distributed, and the cover plate is provided with insertion holes configured for the positioning buckles to be inserted.

Optionally, the shaving head assembly further includes a floating pressing plate arranged in the gear frame, and a floating elastic member with two ends respectively abutting against the connecting seat and the floating pressing plate, the snap-fit member and the floating pressing plate are electrically connected through a first conductor, and the floating pressing plate, the floating elastic member, and the connecting seat are electrically connected in sequence and serve as a part of the first conductive path.

Optionally, the floating pressing plate is provided with a connecting post, the first conductor is elastic members, one end of the first conductor is sleeved on the connecting post, and the other end of the first conductor is abutted on the snap-fit member.

Optionally, the connecting seat is provided with a mounting cavity, an inner wall of the connecting seat is provided with a first positioning boss, and the floating pressing plate is provided with a second positioning boss, two ends of the floating elastic member are respectively sleeved on the first positioning boss and the second positioning boss.

An embodiment of the present application provides a handle assembly configured for connecting the shaving head assembly above-mentioned, and the handle assembly includes: a casing; a motor, mounted in the casing and configured for powering the rotating cutter head; and a circuit board assembly, mounted in the casing; the circuit board assembly is electrically connected to a second end of the first conductive path and configured for activating the motor when receiving the first inductive capacitor.

Optionally, the circuit board assembly is provided with a first receiving end electrically connected to the second end of the first conductive path to receive the first inductive capacitor, the circuit board assembly is provided with a first capacitor electrically connected to the first receiving end and configured for determining a reference capacitor, the circuit board assembly comprises a controller configured for activating the motor when the first receiving end obtains the first inductive capacitor.

Optionally, the handle assembly further includes an upper cover mounted at an end port of the casing, the upper cover is provided with an insertion slot configured for the connecting seat to be inserted into, the connecting seat is detachably mounted on the upper cover, and the connecting seat is electrically connected to the upper cover and serves as a part of the first conductive path.

Optionally, a side wall of the insertion slot is provided with a through hole, and the handle assembly further comprises a latch fastener penetrated through the through hole and elastic members configured for pushing the latch fastener, the connecting seat is further provided with a latching position for the latch fastener to be engaged into, and the upper cover, the latch fastener, and the elastic member are electrically connected in sequence and serve as a part of the first conductive path.

Optionally, the handle assembly further includes an inner shell mounted in the casing, a second conductor mounted on the inner shell, and a third conductor mounted on the inner shell and electrically connected to the second conductor, the circuit board assembly is mounted on the inner shell, the second conductor is abutted on one of the elastic members, and the third conductor is electrically connected to the first receiving end.

Optionally, the second conductor is arranged on an upper end of the inner shell; the third conductor is strip-shaped and arranged on an outer surface of the inner shell; the second conductor and the third conductor are electrically connected by screws passing through the inner shell.

Optionally, the handle assembly further includes a wake-up sensor for switching the motor to a standby state.

Optionally, the casing is a conductive casing; the circuit board assembly is provided with a second receiving end configured for receiving a second inductive capacitor between the casing and the ground when the casing approaches or contacts human skin, the circuit board assembly is provided with a second capacitor electrically connected to the second receiving end and configured for determining a reference capacitor; and the controller is further configured for controlling the motor being in a standby state when the second receiving end obtains the second inductive capacitor; and

the wake-up sensor comprises a second conductive path, the casing serves as a first end of the second conductive path, and a second end of the second conductive path is electrically connected to the second receiving end.

Optionally, the handle assembly further includes an inner shell mounted in the casing and a fourth conductor mounted on the inner shell, one end of the fourth conductor is abutted on the casing, and the other end is electrically connected to the second receiving end.

Optionally, the circuit board assembly further includes a touch signal processor, the first receiving end and the second receiving end are both arranged on the touch signal processor, and the controller is electrically connected to the touch signal processor.

An embodiment of the present application provides an inductive shaver, which includes the shaving head assembly above-mentioned and the handle assembly above-mentioned, and the shaving head assembly is connected to the handle assembly.

### BENEFIT EFFECT

The above-mentioned one or more technical solutions in the embodiments of the present application have at least one of the following technical effects:

In the shaving head assembly, the connecting base is electrically connected with the holder, and when the connecting base is connected to the handle assembly, the holder or the cutters serves as the first end of the first conductive path. When shaving, the holder or the cutters are arranged approaching the human skin such as the chin and cheeks; because the human skin has a certain electric charge, when the human skin directly contacts or approaches the holder or cutters, the holder or cutters will absorb human skin capacitance formed between the approaching position and the ground, which is the first inductive capacitor, and the signal of the first inductive capacitor is served as the signal to activate the motor.

In the handle assembly, the second end of the first conductive path is connected to the circuit board assembly, and when the circuit board assembly receives the first inductive capacitor, the motor is activated to drive the rotating cutter head in the cutting unit to rotate.

The inductive shaver includes the above-mentioned shaving head assembly and the above-mentioned handle assembly. The shaver is configured with the first conductive path, the first end of the first conductive path is the holder or the cutters in the shaving head assembly, and the second end is connected to the circuit board assembly in the handle assembly. When shaving, the holder or the cutters are arranged approaching the human skin such as the chin and cheeks; because the human skin has a certain electric charge, when the human skin directly contacts or approaches the holder or cutters, the holder or cutters will absorb human skin capacitance formed between the approaching position and the ground, which is the first inductive capacitor. When the circuit board assembly receives the first inductive capacitor, the motor is activated to drive the rotating cutter head in the cutting unit to rotate, so as to achieve the purpose of inductive shaving and ensure long-term reliable use of the shaver.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a perspective explosion view of an inductive shaver provided by an embodiment of the present application;

FIG. 2 is a cross-sectional view of an inductive shaver provided by an embodiment of the present application;

FIG. 3 is another cross-sectional view of an inductive shaver provided by an embodiment of the present application;

FIG. 4 is a perspective explosion view of a part of the structure of a shaving head assembly applied in the inductive shaver of FIG. 1;

FIG. 5 is a perspective assembly view of a part of the structure of a shaving head assembly applied in the inductive shaver of FIG. 1;

FIG. 6 is a perspective explosion view of a part of the structure of a shaving head assembly applied in the inductive shaver of FIG. 1;

FIG. 7 is a perspective explosion view of a handle assembly applied in the inductive shaver of FIG. 1;

FIG. 8 is a circuit diagram of the inductive shaver of FIG. 1; and

FIG. 9 is another circuit diagram of an inductive shaver provided by an embodiment of the present application.

### DETAILED DESCRIPTION

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

In the description of the embodiments of the present application, it needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In addition, terms “the first” and “the second” are only used in describe purposes, and should not be considered as indicating or implying any relative importance, or impliedly indicating the number of indicated technical features. As such, technical feature(s) restricted by “the first” or “the second” can explicitly or impliedly comprise one or more such technical feature(s). In the description of the present application, “a plurality of” means two or more, unless there is additional explicit and specific limitation.

In the present application, unless there is additional explicit stipulation and limitation, terms such as “mount”, “connect with each other”, “connect”, “fix”, and so on should be generalizedly interpreted, for example, “connect” can be interpreted as being fixedly connected, detachably connected, or connected integrally; “connect” can also be interpreted as being mechanically connected or electrically connected; “connect” can be further interpreted as being directly connected or indirectly connected through intermediary, or being internal communication between two components or an interaction relationship between the two components. For the one of ordinary skill in the art, the specific meanings of the aforementioned terms in the present application can be interpreted according to specific conditions.

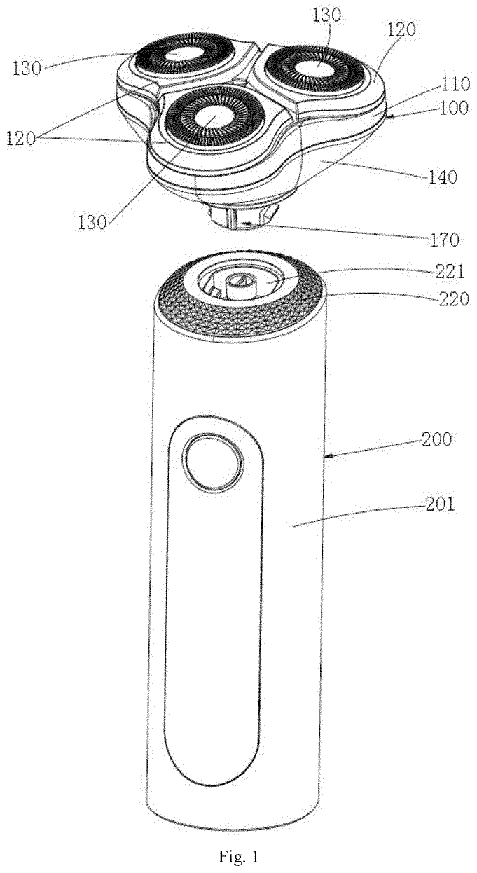

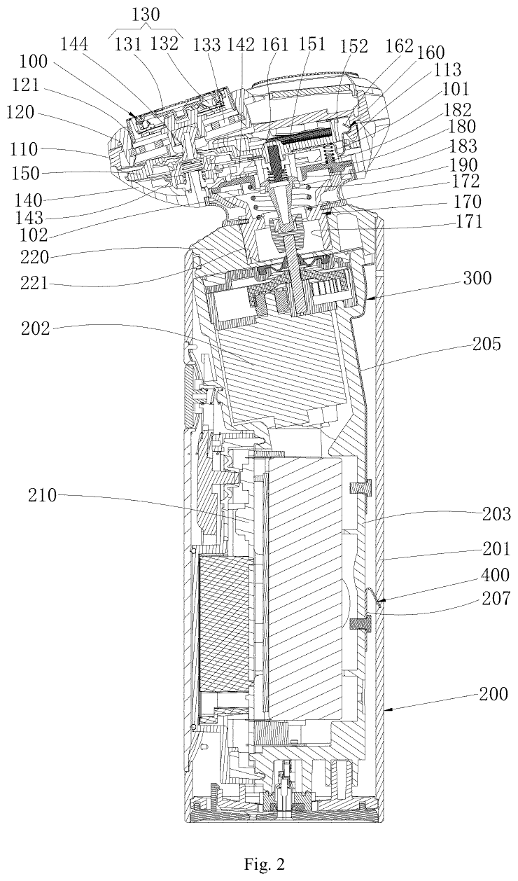

Referring to FIGS. 1 and 2, an embodiment of the present application provides an inductive shaver, including a shaving head assembly 100 and a handle assembly 200, and the shaving head assembly 100 is mounted on the handle assembly 200. The shaving head assembly 100 includes a head cover 110, a holder 120 mounted on the head cover 110, a cutting unit 130 mounted on the holder 120, and a connecting seat 170 for connecting with the handle assembly 200. The connecting seat 170 is electrically connected with the holder 120. The cutting unit 130 includes cutters 131 mounted on the holder 120 and a rotating cutter head 132 arranged in the cutters 131 and used for cutting. The cutters 131 are in contact with the holder 120 so that the two are electrically connected. The holder 120 or the cutters 131 is served as the first end of the first conductive path 300, and the first conductive path 300 is used to receive a first inductive capacitor Cf1 between holder 120 (or the cutters 131) and the ground (GND) when the holder 120 (or the cutters 131) approaches of contacts the human skin 1. The handle assembly 200 includes a casing 201, a motor 202 mounted in the casing 201 and used to provide power to the rotating cutter head 132, and a circuit board assembly 210 mounted in the casing 201. The circuit board assembly 210 is electrically connected to the second end of the first conductive path 300 and is used to activate the motor 202 when receiving the first inductive capacitor Cf1.

Compared with the prior art, the inductive shaver provided by the present application, referring to FIGS. 1, 2 and 8, the inductive shaver includes the shaving head assembly 100 and the handle assembly 200. The shaver is configured with the first conductive path 300, the first end of the first conductive path 300 is the holder 120 or the cutters 131 in the shaving head assembly 100, and the second end is connected to the circuit board assembly 210 in the handle assembly 200. When shaving, the holder 120 (or the cutters 131) is arranged approaching the human skin 1 such as the chin and cheeks; because the human skin 1 has a certain electric charge, when the human skin 1 directly contacts or approaches the holder 120 (or the cutters 131), the holder 120 (or the cutters 131) will absorb human skin capacitance formed between the approaching position and the ground, which is the first inductive capacitor Cf1. When the circuit board assembly 210 receives the first inductive capacitor Cf1, the motor 202 is activated to drive the rotating cutter head 132 in the cutting unit 130 to rotate, so as to achieve the purpose of inductive shaving and ensure long-term reliable use of the shaver.

Specifically, when no human skin 1 approaches the holder 120 (or cutters 131), there is no first inductive capacitor Cf1 between the human skin 1 and the ground; when the human skin 1 approaches the holder 120 (or the cutters 131), a first inductive capacitor Cf1 is formed between the holder 120 (or the cutters 131) and the ground. Before and after the human skin 1 approaches the holder 120 (or the cutters 131), the circuit board assembly 210 receives the change signal of the first inductive capacitor Cf1, and at this time, the motor 202 is activated.

Referring to FIGS. 1 and 2, an embodiment of the present application provides a shaving head assembly 100, which includes a head cover 110, a holder 120 mounted on the head cover 110, a cutting unit 130 mounted on the holder 120, and a connecting seat 170 configured for connecting the handle assembly 200. The connecting seat 170 is electrically connected with the holder 120, the holder 120 (or the cutters 131) is served as the first end of the first conductive path 300, and the first conductive path 300 is used to receive the first inductive capacitor Cf1 between the holder 120 (or the cutters 131) and the ground (GND) when the holder 120 (or the cutters 131) approaches or contacts the human skin 1.

In the shaving head assembly 100, the connecting seat 170 is electrically connected with the holder 120. When the connecting seat 170 is connected to the handle assembly 200, the holder 120 (or the cutters 131) serves as the first end of the first conductive path 300. When shaving, the holder 120 (or the cutters 131) is arranged approaching the human skin 1 such as the chin and cheeks; because the human skin 1 has a certain electric charge, when the human skin 1 directly contacts or approaches the holder 120 (or the cutters 131), the holder 120 (or the cutters 131) will absorb human skin capacitance formed between the approaching position and the ground, which is the first inductive capacitor Cf1, and the signal of the first inductive capacitor Cf1 is served as the signal to activate the motor 202.

In another embodiment of the present application, when the holder 120 or the cutters 131 is (are) served as the first end of the first conductive path 300, the holder 120 is a conductor. It is easy to process the holder 120 by directly using the conductive material. Alternatively, the outer surface of the holder 120 is provided with a conductive layer. By arranging the holder 120 formed by the conductive layer on the outer surface of the plastic member, the weight will be lighter. Similarly, when the cutters 131 are served as the first end of the first conductive path 300, the cutters 131 are conductors. Alternatively, the outer surfaces of the cutters 131 are provided with a conductive layer. Both fabrication methods can be served as the first end of the first conductive path 300, and the holder 120 (or the cutters 131) will absorb the human skin capacitance formed between it and the ground from a position approaching the human skin 1.

Referring to FIGS. 2, 4 and 5, in another embodiment of the present application, the holder 120 is provided with a mounting groove 121, the cutting unit 130 is penetrated through the mounting groove 121 and arranged in the mounting groove 121, and the holder 120 is mounted with a fixing plate 133 for limiting the cutting unit 130. With the structure of the cutting unit 130, the holder 120 and the fixing plate 133, the assembly is simple. Specifically, the cutting unit 130 is inserted into the mounting groove 121 of the holder 120 from bottom to top, and is limited by the bottom edge of the cutting unit 130 to fix the fixing plate 133 on the inner wall of the holder 120. The holder 120 and the head cover 110 are abutted against each other so that the both are electrically connected and serve as a part of the first conductive path 300.

In another embodiment of the present application, the head cover 110 is provided with a mounting hole 111, and the holder 120 is swingably disposed in the mounting hole 111. The holder 120 is swingably arranged on the head cover 110, so that the angle of the holder 120 can be automatically adjusted to fit the human skin 1 during shaving, which provides comfort and better shaving experience. Specifically, the holder 120 is assembled on the head cover 110 by swinging a positioning shaft 112 on the head cover 110, and the positioning shaft 112 is inserted into the connecting hole 122 of the holder 120 to realize the movable mounting of the holder 120 on the head cover 110.

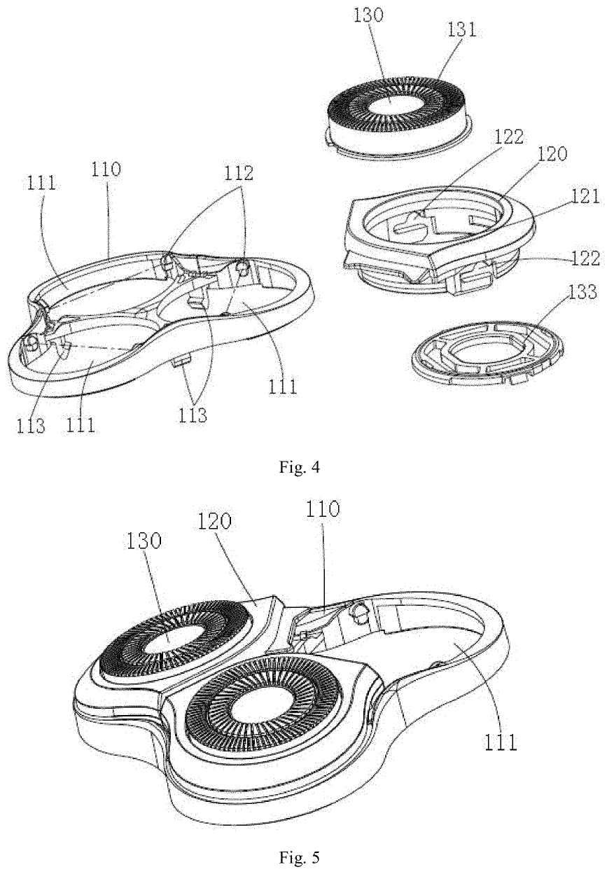

Referring to FIGS. 4, 5 and 8, in another embodiment of the present application, the holders 120 are provided with three, the three holders 120 are distributed in a circumferential direction, and the three holders 120 are distributed in a triangle relative to the swing axis of the head cover 110. In this way, the relative area with the human skin 1 can be increased, and when the user brings the holder 120 (or the cutters 131) approaching the human skin 1, the holder 120 (or the cutters 131) can more easily absorb the human skin capacitance formed between the approaching position to the human skin 1 and the ground, and then transmitted to the circuit board assembly 210.

Referring to FIGS. 2, 3, and 6, in another embodiment of the present application, a gear transmission mechanism is provided between the motor 202 and the shaving head assembly 100, and the gear transmission mechanism includes a driving gear 142 and a driven gear 143 meshed with the driving gear 142, and the driven gear 143 is connected with a connecting shaft 144. The shaving head assembly 100 further includes a gear frame 140 aligned with the head cover 110, a cover plate 150 mounted on one end of the gear frame 140, and a snap-fit member 150 mounted on the cover plate 150 and engaged with the head cover 110, the snap-fit member 150 is configured to connect the head cover 110 and the cover plate 150. When the shaving head assembly 100 is mounted on the handle assembly 200, the motor 202 of the handle assembly 200 drives the driving gear 142 to rotate. The driven gear 143 is rotatably disposed on the gear frame 140, and the connecting shaft 144 of the driven gear 143 passes through the cover plate 150 and is connected to the rotating cutter head 132 of the cutting unit 130 to drive the rotating cutter head 132 to rotate. The head cover 110 abuts against the snap-fit member 150 for electrical connection and serves as a part of the first conductive path 300.

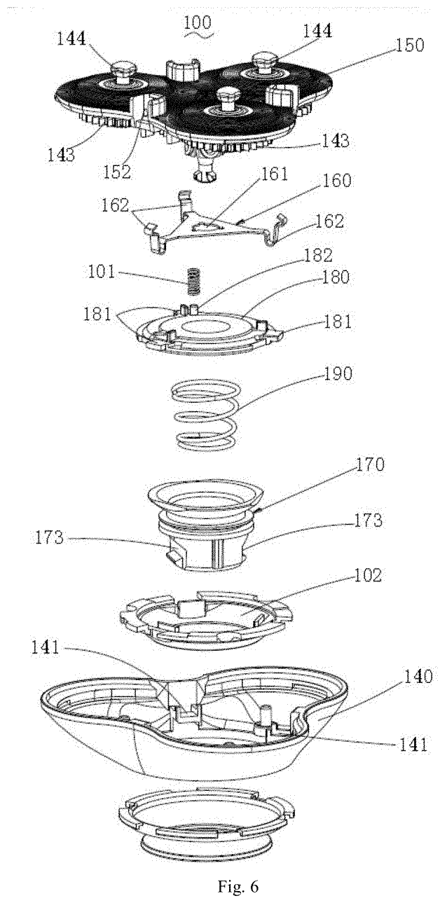

Referring to FIGS. 2 and 6, in another embodiment of the present application, the middle part of the cover plate 150 is provided with a positioning post 151, and the snap-fit member 150 is provided with a positioning hole 161 through which the positioning post 151 passes. The snap-fit member 150 is provided with several positioning buckles 162 circumferentially distributed, and the cover plate 150 is provided with insertion holes 152 for the positioning buckles 162 to insert. The positioning hole 161 is aligned with the positioning post 151 at the bottom of the cover plate 150 and then sleeved on the positioning post 151, then the positioning hole 161 is inserted into the insertion hole 152, and then the snap-fit member 150 can be assembled on the cover plate 150, the connection is reliable and stable.

In another embodiment of the present application, the shaving head assembly 100 further includes a floating pressing plate 180 disposed in the gear frame 140, and a floating elastic member 190 with two ends respectively abutting on the connecting seat 170 and the floating pressing plate 180. The configuration of the connecting seat 170, the floating pressing plate 180 and the floating elastic member 190 can make the cutting unit 130 move in the axial direction, thereby improving the shaving experience of the user. The snap-fit member 150 and the floating pressing plate 180 are electrically connected through the first conductor 101. The floating pressing plate 180, the floating elastic member 190, and the connecting seat 170 are electrically connected in sequence and serve as a part of the first conductive path 300. The snap-fit member 150, the first conductor 101, the floating pressing plate 180, the floating elastic member 190, and the connecting seat 170 are electrically connected in sequence, and the human skin capacitance between the holder 120 (or the cutters 131) and the ground is transmitted to the circuit board assembly 210 in the handle assembly 200. Specifically, the outer edge of the floating pressing plate 180 is provided with a limiting structure 181, the floating pressing plates 180 are fixed together by the positioning grooves 141 on the gear frame 140, and the limiting structure 181 can be engaged in the positioning groove 141. A trim ring pressing plate 102 is assembled on the gear frame 140 by the positioning fit of the connecting seat 170, and then being assembled together with floating elastic member 190 and the floating pressing plate 180 by the connecting seat 170.

In another embodiment of the present application, the floating pressing plate 180 is provided with a connecting post 182, the first conductor 101 is elastic members, one end of the first conductor 101 is sleeved on the connecting post 182, and the other end of the first conductor 101 is abutted on the connecting post 182. By using the elastic first conductor 101, the reliable electrical connection between the floating pressing plate 180 and the snap-fit member 150 can be ensured. The first conductor 101 is positioned and assembled on the floating pressing plate 180 by using the connecting post 182, so that the connection between the first conductor 101 and the floating pressing plate 180 is reliable.

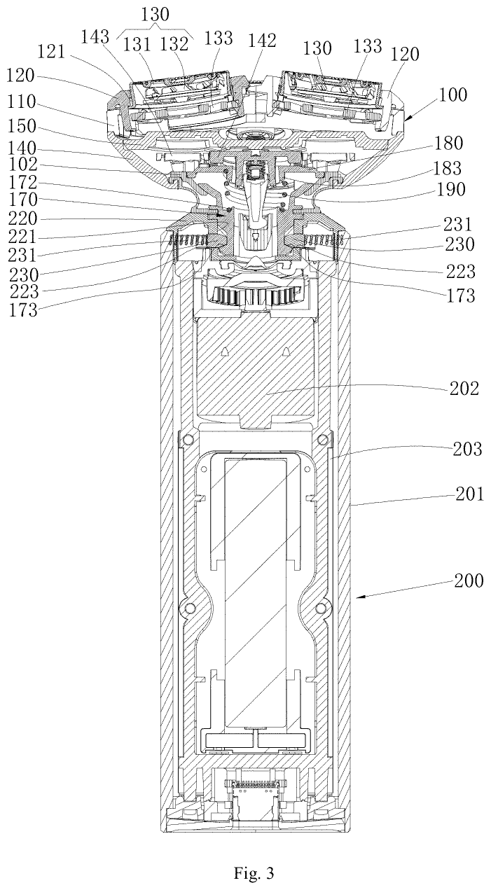

Referring to FIGS. 2 and 3, in another embodiment of the present application, the connecting seat 170 is provided with a mounting cavity 171, the inner wall of the connecting seat 170 is provided with a first positioning boss 172, and the floating pressing plate 180 is provided with a second positioning boss 183, two ends of the floating elastic member 190 are respectively sleeved on the first positioning boss 172 and the second positioning boss 183. This assembly method ensures that the two ends of the floating elastic member 190 reliably abut on the connecting seat 170 and the floating pressing plate 180 to ensure reliable electrical connection.

Referring to FIGS. 2 and 4, in another embodiment of the present application, a plurality of buckles 113 are provided on the head cover 110, and the buckles 113 of the head cover 110 are aligned with the insertion holes 152 on the cover plate 150, and the buckles 113 are tightly combined with the positioning buckles 162 of the snap-fit member 150 to achieve a detachable fit between the head cover 110 and the cover plate 150.

Referring to FIGS. 1 and 2, an embodiment of the present application provides a handle assembly 200, and the handle assembly 200 is configured to connect the above-mentioned shaving head assembly 100. The handle assembly 200 includes a casing 201, a motor 202 mounted in the casing 201 and used to power the cutting unit 130, and a circuit board assembly 210 mounted in the casing 201. The circuit board assembly 210 is electrically connected to the second end of the first conductive path 300, and is configured for activating the motor 202 when receiving the first inductive capacitor Cf1.

In the handle assembly 200, the circuit board assembly 210 is electrically connected to the second end of the first conductive path 300. When the circuit board assembly 210 receives the first inductive capacitor Cf1, the motor 202 is activated to drive the rotating cutter head 132 in the cutting unit 130 to rotate.

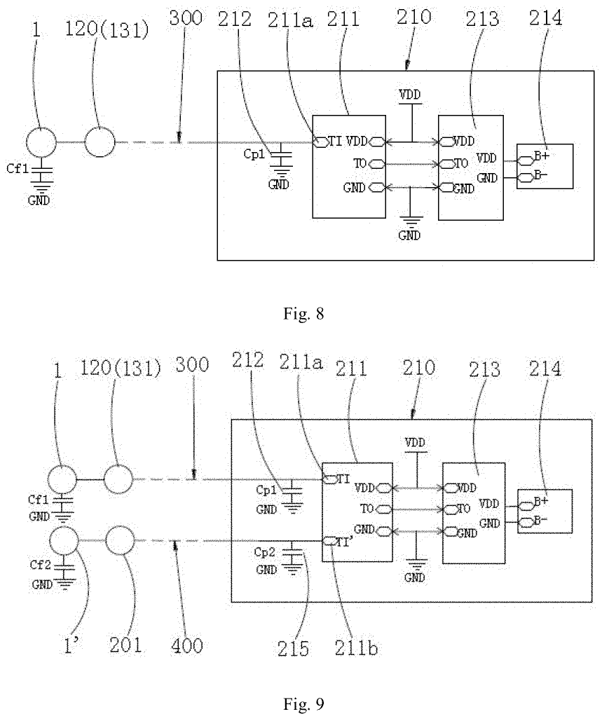

Referring to FIG. 8 at the same time, in another embodiment of the present application, the circuit board assembly 210 is provided with a first receiving end 211a that is electrically connected to the second end of the first conductive path 300 to receive the first inductive capacitor Cf1, and the circuit board assembly 210 is provided with a first capacitor 212 electrically connected to the first receiving end 211a and used for determining the reference capacitor Cp1, the circuit board assembly 210 includes a controller 213 for activating the motor 202 when the first receiving end 211a obtains the first inductive capacitor Cf1. The first inductive capacitor Cf1 and the reference capacitor Cp1 are connected in parallel to the first receiving end 211a. When there is no human skin 1 approaching the holder 120 (or cutters 131), there is no the first inductive capacitor Cf1 formed between the human skin 1 and the ground, only the reference capacitor Cp1 on the circuit board assembly 210; when there is human skin 1 approaching the holder 120 (or cutters 131), the first inductive capacitor Cf1 is formed between the holder 120 (or cutters 131) and the ground. Since Cf1 and Cp1 are connected in parallel, before and after the human skin 1 approaches the holder 120 (or the cutters 131), the total capacitor produces a capacitance change after entering the first receiving end 211 a. That is, when the first receiving end 211a obtains the change signal of the first inductive capacitor Cf1, the controller 213 activates the motor 202 to drive the rotating cutter head 132 in the cutting unit 130 to rotate.

Referring to FIGS. 1, 2 and 7, in another embodiment of the present application, the handle assembly 200 further includes an upper cover 220 mounted at an end port of the casing 201, and the upper cover 220 has an insertion slot 221 for the connecting seat 170 to be inserted, the connecting seat 170 is detachably mounted on the upper cover 220, and the connecting seat 170 is electrically connected with the upper cover 220 as a part of the first conductive path 300. The structure in which the connecting seat 170 is detachably mounted on the upper cover 220 is adopted, so that the shaving head assembly 100 can be easily disassembled for cleaning.

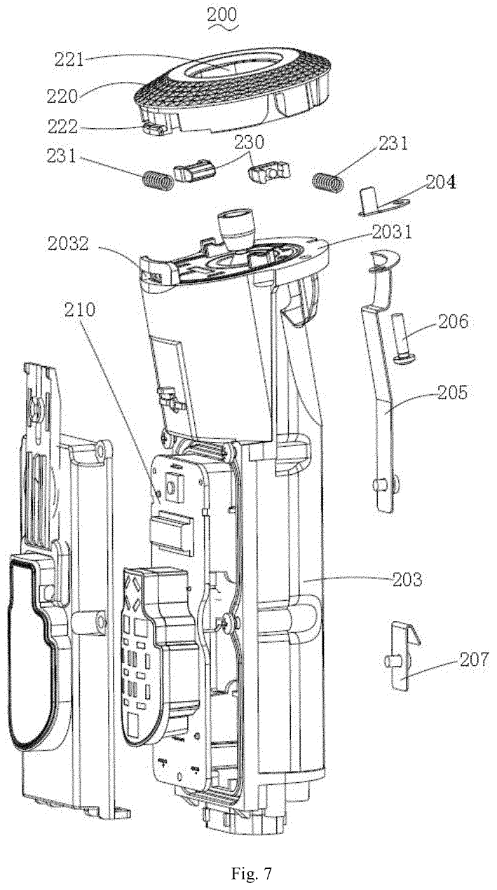

Referring to FIGS. 3 and 7, in another embodiment of the present application, a side wall of the insertion slot 221 is provided with a through hole 223, and the handle assembly 200 further includes a latch fastener 230 penetrated through the through hole 223 and elastic members 231 configured for pushing the latch fastener 230, referring to FIG. 6 together, the connecting seat 170 is provided with a latching position 173 for the latch fastener 230 to be engaged into. When inserting the connecting seat 170 into the insertion slot 221 of the upper cover 220, and under the action of the elastic member 231, the latch fastener 230 is engaged into the latching position 173 of the connecting seat 170 to lock the connecting seat 170 on the upper cover 220. Disassembly is accomplished by pulling out the handle assembly 200. The assembly and disassembly are very convenient. When the connecting seat 170 is mounted on the upper cover 220, the connecting seat 170 is abutted on the upper cover 220 to be electrically connected, and the upper cover 220, the latch fastener 230, and the elastic member 231 are electrically connected in sequence and serve as a part of the first conductive path 300. The human skin capacitance is transmitted to the inside of the handle assembly 200.

Referring to FIGS. 2 and 7, in another embodiment of the present application, the handle assembly 200 further includes an inner shell 203 mounted in the casing 201, a second conductor 204 mounted on the inner shell 203, and a third conductor 205 mounted on the inner shell 203 and is electrically connected to the second conductor 204. The circuit board assembly 210 is mounted on the inner shell 203. The second conductor 204 is abutted on one of the elastic members 231, and the third conductor 205 is electrically connected to the first receiving end 211a. The third conductor 205 may be assembled to the inner shell 203 by riveting or other mechanical connection. The use of the inner shell 203 facilitates the assembly of devices such as the circuit board assembly 210. The signal is transmitted to the first receiving end 211a through the second conductor 204 and the third conductor 205, and the assembly is convenient and the structure is compact.

Referring to FIG. 7, in another embodiment of the present application, the second conductor 204 is disposed on the upper surface of the upper end platform 2031 of the inner shell 203; the third conductor 205 is strip-shaped and disposed on the outer surface of the inner shell 203, and one end of the third conductor 205 is located on the lower surface of the upper end platform 2031 of the inner shell 203; the second conductor 204 and the third conductor 205 are respectively provided with a round hole, and the screws 206 pass through the round hole of the second conductor 204, the round hole of the upper end platform 2031, and the round hole of the third conductor 205, to fixedly connect the third conductor 205, the inner shell 203, and the second conductor 204. The second conductor 204 and the third conductor 205 are electrically connected by screws 206 passing through the inner shell 203. The fixing buckle 222 of the upper cover 220 is assembled together with the engagement hole 2032 on the top edge of the inner shell 203, so that one of the elastic members 231 is connected to the second conductor 204.

Referring to FIGS. 2 and 7, in another embodiment of the present application, when the holder 120 is served as the first end of the first conductive path 300, the first conductive path 300 of the inductive shaver passes through the holder 120, the head cover 110, the snap-fit member 150, the first conductor 101, the floating pressing plate 180, the floating elastic member 190, the connecting seat 170, the upper cover 220, the latch fastener 230, the elastic member 231, the second conductor 204, the screws 206, and the third conductor 205 and finally transmitted to the first receiving end 211a of the circuit board assembly 210.

When the cutters 131 are served as the first end of the first conductive path 300, the first conductive path 300 of the inductive shaver passes through the cutters 131, the holder 120, the head cover 110, the snap-fit member 150, the first conductor 101, the floating pressing plate 180, the floating elastic member 190, the connecting seat 170, the upper cover 220, the latch fastener 230, the elastic member 231, the second conductor 204, the screws 206, and the third conductor 205 and finally transmitted to the first receiving end 211a of circuit board assembly 210.

Specifically, the surfaces of the above parts are treated with a conductive coating to achieve a conductive state, and are assembled into a complete first conductive path 300 through structural cooperation between the parts.

Referring to FIGS. 2 and 8, in another embodiment of the present application, the circuit board assembly 210 further includes a touch signal processor 211, the first receiving end 211 a is arranged on the touch signal processor 211, and the controller 213 is electrically connected with the touch signal processor 211. The touch signal processor 211 belongs to the prior art, and the touch signal processor 211 can receive electrical signals, determine the magnitude of the capacitance change, and then output a trigger signal to the controller 213. Specifically, a touch signal processor 211 with a model of ASC8022S or BS83A02C can be used. When there is no human skin 1 approaching the holder 120 (or cutters 131), there is no capacitor Cf1 formed between the human skin 1 and the ground, only the reference capacitor Cp1 on the circuit board assembly 210; when there is human skin 1 approaching the holder 120 (or cutters 131), the first inductive capacitor Cf1 is formed between the holder 120 (or cutters 131) and the ground, the Cf1 and Cp1 are connected in parallel. Before and after the human skin 1 approaches the holder 120 (or the cutters 131), the total capacitor produces a capacitance change after entering the touch signal processor 211. This total capacitance change causes the change of the internal oscillation frequency or charging and discharging time of the touch signal processor 211, so that the touch signal processor 211 can detect the touch signal TI, and the touch signal processor 211 thus generates the trigger signal TO (touch output level signal) to the controller 213; when there is no touching or approaching, TO has no valid signal outputting. When the controller 213 detects a valid signal TO, the controller 213 outputs relevant signals to the motor 202 through an internal interrupt processing, thereby, the motor is controlled to rotate and then to rotate the rotating cutter head 132 in the cutting unit 130. The controller 213 is connected to the power source 214 to power the various devices. The power source 214 can be a battery provided within the casing 201.

Referring to FIG. 2, in another embodiment of the present application, the handle assembly 200 further includes a wake-up sensor for switching the motor 202 to a standby state. The arrangement of the wake-up sensor can avoid the situation that only the first conductive path 300 is provided and the motor 202 will be activated by mistake. When in use, the motor 202 must be in the standby state by the wake-up sensor first, and then the first conductive path 300 can realize the induction of the human skin 1 approaching the holder 120 (or the cutters 131) to activate the motor 202.

Referring to FIGS. 2 and 9, in another embodiment of the present application, the casing 201 is a conductive casing; the circuit board assembly 210 is provided with a second receiving end 211b configured for receiving a second inductive capacitor Cf2 between the casing 201 and the ground (GND) when the casing 201 approaches or contacts the human skin 1′ (hand), the circuit board assembly 210 is provided with a second capacitor 215 that is electrically connected to the second receiving end 211b and configured for determining a reference capacitor Cp2; the controller 213 is also configured for controlling the motor 202 being in a standby state When the second receiving end 211b obtains the second inductive capacitor Cf2; the wake-up sensor includes a second conductive path 400, the casing 201 is served as the first end of the second conductive path 400, and the second end of the second conductive path 400 is electrically connected to the second receiving end 211b. When in used, the casing 201 of the handle assembly 200 is held by hand firstly, and due that the human skin 1′ (hand) has a certain electric charge, when the human skin 1′ directly touches or approaches the conductive casing 201, the casing 201 absorbs the human skin capacitance between the approaching or contacting position and the ground, that is, the second inductive capacitor Cf2. The second sensing capacitor Cf2 and the reference capacitor Cp2 are connected in parallel to the second receiving end 211b, and when the second receiving end 211b obtains the second inductive capacitor Cf2, the controller 213 wakes up the motor 202 to switch to the standby state. Specifically, the second receiving end 211b is provided on the above-mentioned touch signal processor 211, and the connection between the second conductive path 400, the second capacitor 215 and the second receiving end 211b is similar to that of the first conductive path 300, the first capacitor 212 and the first receiving end 211a.

Specifically, when there is no human skin 1′ (hand) approaching the casing 201, there is no second inductive capacitor Cf2 between the human skin 1′ and the ground, and only the reference capacitor Cp2 on the circuit board assembly 210; when there is human skin 1′ approaching the casing 201, the second inductive capacitor Cf2 is formed between the casing 201 and the ground. Since Cf2 and Cp2 are connected in parallel, before and after the human skin 1′ approaches the casing 201, the total capacitance produces a capacitance change after entering the second receiving end 211b. That is, the second receiving end 211b obtains the change signal of the second sensing capacitor Cf2, and at this time, the controller 213 controls the motor 202 in a standby state.

Referring to FIGS. 2 and 7, in another embodiment of the present application, the handle assembly 200 further includes an inner shell 203 mounted in the casing 201 and a fourth conductor 207 mounted on the inner shell 203. One end of the fourth conductor 207 is abutted on the casing 201, and the other end is electrically connected to the second receiving end 211b. The fourth conductor 207 is configured to realize the electrical connection between the second receiving end 211b and the casing 201. After the human hand holds the casing 201, the signal of the second sensing capacitor Cf2 can be reliably transmitted to the second receiving end 211b. The fourth conductor 207 may be an elastic bending member, and one end of the bending member is abutted on the inner wall of the casing 201 to achieve stable electrical connection between the casing 201 and the fourth conductor 207. The fourth conductor 207 can be mounted on the inner shell by riveting or other mechanical connection.

The above are only preferred embodiments of the present application and are not intended to limit the present application. Any modifications, equivalent replacements and improvements made within the principles of the present application shall be included within the protection scope of the present application.

1. A shaving head assembly, comprising:
a head cover;
a holder, mounted on the head cover;
a cutting unit, mounted on the holder, and the cutting unit comprising cutters mounted on the holder and a rotating cutter head arranged in cutters; and
a connecting seat, configured for connecting to a handle assembly, and the connecting seat being electrically connected with the holder;
wherein the holder is served as a first end of a first conductive path, and the first conductive path is configured for receiving a first inductive capacitor between the holder and the ground when the holder approaches or contacts human skin; or
wherein the cutters are served as a first end of a first conductive path, and the first conductive path is configured for receiving a first inductive capacitor between the cutters and the ground when the cutters approach or contact human skin.

2. The shaving head assembly according to claim 1, wherein when the holder or the cutters is served as the first end of the first conductive path, the holder is configured as a conductor; or an outer surface of the holder is provided with a conductive layer; and
when the cutters are served as the first end of the first conductive path, the cutters are configured as conductors; or an outer surface of the cutters is provided with a conductive layer.

3. The shaving head assembly according to claim 1, wherein the holder is provided with a mounting groove, the cutting unit is arranged in the mounting groove, the holder is mounted with a fixing plate configured for limiting the cutting unit, and the holder is electrically connected to the head cover and serves as a part of the first conductive path.

4. The shaving head assembly according to claim 3, wherein the head cover is provided with a mounting hole, and the holder is swingably arranged in the mounting hole.

5. The shaving head assembly according to claim 1, wherein the shaving head assembly further comprises a gear frame aligned with the head cover, a cover plate mounted on one end of the gear frame, and a snap-fit member mounted on the cover plate and engaged with the head cover, the head cover is electrically connected with the snap-fit member and serves as a part of the first conductive path.

6. The shaving head assembly according to claim 5, wherein a middle part of the cover plate is provided a positioning post, the snap-fit member is provided with a positioning hole configured for the positioning post passing through; the snap-fit member is provided with a plurality of positioning buckles circumferentially distributed, and the cover plate is provided with insertion holes configured for the positioning buckles to be inserted.

7. The shaving head assembly according to claim 5, wherein the shaving head assembly further comprises a floating pressing plate arranged in the gear frame, and a floating elastic member with two ends respectively abutting against the connecting seat and the floating pressing plate, the snap-fit member and the floating pressing plate are electrically connected through a first conductor, and the floating pressing plate, the floating elastic member, and the connecting seat are electrically connected in sequence and serve as a part of the first conductive path.

8. The shaving head assembly according to claim 7, wherein the floating pressing plate is provided with a connecting post, the first conductor is elastic members, one end of the first conductor is sleeved on the connecting post, and an other end of the first conductor is abutted on the snap-fit member.

9. The shaving head assembly according to claim 7, wherein the connecting seat is provided with a mounting cavity, an inner wall of the connecting seat is provided with a first positioning boss, and the floating pressing plate is provided with a second positioning boss, two ends of the floating elastic member are respectively sleeved on the first positioning boss and the second positioning boss.

10. A handle assembly, configured for connecting a shaving head assembly and the shaving head assembly comprising:
a head cover;
a holder, mounted on the head cover;
a cutting unit, mounted on the holder, and the cutting unit comprising cutters mounted on the holder and a rotating cutter head arranged in cutters; and
a connecting seat, configured for connecting to a handle assembly, and the connecting seat being electrically connected with the holder;
wherein the holder is served as a first end of a first conductive path, and the first conductive path is configured for receiving a first inductive capacitor between the holder and ground when the holder approaches or contacts human skin; or
wherein the cutters are served as a first end of a first conductive path, and the first conductive path is configured for receiving a first inductive capacitor between the cutters and the ground when the cutters approach or contact human skin; and
the handle assembly comprising:
a casing;
a motor, mounted in the casing and configured for powering the rotating cutter head; and
a circuit board assembly, mounted in the casing;
wherein the circuit board assembly is electrically connected to a second end of the first conductive path and configured for activating the motor when receiving the first inductive capacitor.

11. The handle assembly according to claim 10, wherein the circuit board assembly is provided with a first receiving end electrically connected to the second end of the first conductive path to receive the first inductive capacitor, the circuit board assembly is provided with a first capacitor electrically connected to the first receiving end and configured for determining a reference capacitor, the circuit board assembly comprises a controller configured for activating the motor when the first receiving end obtains the first inductive capacitor.

12. The handle assembly according to claim 11, wherein the handle assembly further comprises an upper cover mounted at an end port of the casing, the upper cover is provided with an insertion slot configured for the connecting seat to be inserted into, the connecting seat is detachably mounted on the upper cover, and the connecting seat is electrically connected to the upper cover and serves as a part of the first conductive path.

13. The handle assembly according to claim 12, wherein a side wall of the insertion slot is provided with a through hole, and the handle assembly further comprises a latch fastener penetrated through the through hole and elastic members configured for pushing the latch fastener, the connecting seat is further provided with a latching position for the latch fastener to be engaged into, and the upper cover, the latch fastener, and the elastic members are electrically connected in sequence and serve as a part of the first conductive path.

14. The handle assembly according to claim 13, wherein the handle assembly further comprises an inner shell mounted in the casing, a second conductor mounted on the inner shell, and a third conductor mounted on the inner shell and electrically connected to the second conductor, the circuit board assembly is mounted on the inner shell, the second conductor is abutted on one of the elastic members, and the third conductor is electrically connected to the first receiving end.

15. The handle assembly according to claim 14, wherein the second conductor is arranged on an upper end of the inner shell; the third conductor is strip-shaped and arranged on an outer surface of the inner shell; the second conductor and the third conductor are electrically connected by screws passing through the inner shell.

16. The handle assembly according to claim 11, wherein the handle assembly further comprises a wake-up sensor for switching the motor to a standby state.

17. The handle assembly according to claim 16, wherein the casing is a conductive casing; the circuit board assembly is provided with a second receiving end configured for receiving a second inductive capacitor between the casing and the ground when the casing approaches or contacts human skin, the circuit board assembly is provided with a second capacitor electrically connected to the second receiving end and configured for determining a reference capacitor; and the controller is further configured for controlling the motor being in a standby state when the second receiving end obtains the second inductive capacitor; and
the wake-up sensor comprises a second conductive path, the casing serves as a first end of the second conductive path, and a second end of the second conductive path is electrically connected to the second receiving end.

18. The handle assembly according to claim 17, wherein the handle assembly further comprises an inner shell mounted in the casing and a fourth conductor mounted on the inner shell, one end of the fourth conductor is abutted on the casing, and an other end is electrically connected to the second receiving end.

19. The handle assembly according to claim 17, wherein the circuit board assembly further comprises a touch signal processor, the first receiving end and the second receiving end are both arranged on the touch signal processor, and the controller is electrically connected to the touch signal processor.

20. An inductive shaver, comprising a shaving head assembly and a handle assembly, the shaving head assembly comprising:
a head cover;
a holder, mounted on the head cover;
a cutting unit, mounted on the holder, and the cutting unit comprising cutters mounted on the holder and a rotating cutter head arranged in cutters; and
a connecting seat, configured for connecting to a handle assembly, and the connecting seat being electrically connected with the holder;
wherein the holder is served as a first end of a first conductive path, and the first conductive path is configured for receiving a first inductive capacitor between the holder and ground when the holder approaches or contacts human skin; or
wherein the cutters are served as a first end of a first conductive path, and the first conductive path is configured for receiving a first inductive capacitor between the cutters and the ground when the cutters approach or contact human skin; and
the handle assembly comprising:
a casing;
a motor, mounted in the casing and configured for powering the rotating cutter head; and
a circuit board assembly, mounted in the casing;
wherein the circuit board assembly is electrically connected to a second end of the first conductive path and configured for activating the motor when receiving the first inductive capacitor; and
wherein the shaving head assembly is connected to the handle assembly.
